(19) United States
(12) Patent Application Publication
(10) Pub. No.: US 2013/0171982 A1
(43) Pub. Date: Jul. 4, 2013

(54) METHOD AND APPARATUS FOR REMOTE SECURE ACCESS TO WIRELESS NETWORK

(71) Applicants: Brian Barritt, Avon Lake, OH (US); Scott Boswell, Copley, OH (US)

(72) Inventors: Brian Barritt, Avon Lake, OH (US); Scott Boswell, Copley, OH (US)

(73) Assignee: CISCO TECHNOLOGY, INC., San Jose, CA (US)

(21) Appl. No.: 13/338,502

(22) Filed: Dec. 28, 2011

(51) Int. Cl. H04W 8/00; H04W 48/20

(52) U.S. Cl. 455/422.1

(57) ABSTRACT

In one embodiment, a method includes initiating at a mobile device, a secure connection with a wireless controller of a wireless network, receiving traffic from a wireless client device at the mobile device, and transmitting the traffic to the wireless controller over the secure connection. The mobile device is located remote from the wireless network. An apparatus and logic are also disclosed.

### TECHNICAL FIELD

The present disclosure relates generally to wireless networks, and more particularly, to remote secure access to a wireless network.

### BACKGROUND

The number of employees that work at remote sites such as home offices continues to increase. Telecommuting (also referred to as teleworking) enables employees to enjoy work schedule flexibility and an environmentally friendly alternative to commuting, while being productive from any location. One difficulty in telecommuting is that the employee needs access to networked business services from remote locations. Providing employees access to networked business services' from a residential environment poses challenges for both the end user and business operations. For the teleworker, it is important that access to business services be reliable and consistent to provide an experience that is similar to sitting in an office in the organization's facility. Challenges for the business operations include properly securing, maintaining, and managing the teleworker environment from a centralized location.

### BRIEF DESCRIPTION OF THE DRAWINGS

FIG. 1 illustrates an example of a network in which embodiments described herein may be implemented.

FIG. 2 depicts an example of a mobile device useful in implementing embodiments described herein.

FIG. 3 is a flowchart illustrating a process for providing remote secure access to a wireless network at the mobile device, in accordance with the embodiment.

Corresponding reference characters indicate corresponding parts throughout the several views of the drawings.

### DESCRIPTION OF EXAMPLE EMBODIMENTS

### Overview

In one embodiment, a method generally comprises initiating at a mobile device, a secure connection with a wireless controller of a wireless network, receiving traffic from a wireless client device at the mobile device, and transmitting the traffic to the wireless controller over the secure connection. The mobile device is located remote from the wireless network.

In another embodiment, an apparatus generally comprises a processor for initiating at a mobile device, a secure connection with a wireless controller of a wireless network located remote from the mobile device, receiving traffic from a wireless client device and transmitting the traffic to the wireless controller over the secure connection. The apparatus further includes memory for storing an identifier for the wireless controller

### Example Embodiments

The following description is presented to enable one of ordinary skill in the art to make and use the embodiments. Descriptions of specific embodiments and applications are provided only as examples, and various modifications will be readily apparent to those skilled in the art. The general principles described herein may be applied to other applications without departing from the scope of the embodiments. Thus, the embodiments are not to be limited to those shown, but are to be accorded the widest scope consistent with the principles and features described herein. For purpose of clarity, details relating to technical material that is known in the technical fields related to the embodiments have not been described in detail.

One option for providing access to networked business services is to provide a remote access point, which extends an enterprise by delivering secure and manageable network services to teleworkers and employees working outside of a traditional office environment. For example, the access point can plug into a router with an Internet connection and extend a corporate wireless network to remote sites, providing connectivity to workers at temporary workspaces or locations outside of the traditional corporate office without the need for VPN (Virtual Private Network) client installation and configuration at a network device located at the remote office. However, this requires teleworkers or employers to purchase, and deploy physical access points at remote locations along with routers and modems.

The embodiments described herein provide a method and apparatus for securely extending a corporate wireless network to a remote location via a mobile device. As described device is used to establish a secure tunnel to the corporate network and provisioned as a corporate network hotspot so that remote users can access data, voice, video, and other networked business services (e.g., cloud services, conferencing services) for a mobility experience consistent with that at the corporate office. The embodiments allow wireless service providers to offer wireless, enterprise network connectivity to teleworkers at remote locations. There is no need for preexisting wired infrastructure such as a wired local area network. Any user with a mobile device incorporating the embodiments can extend the corporate wireless network to their location.

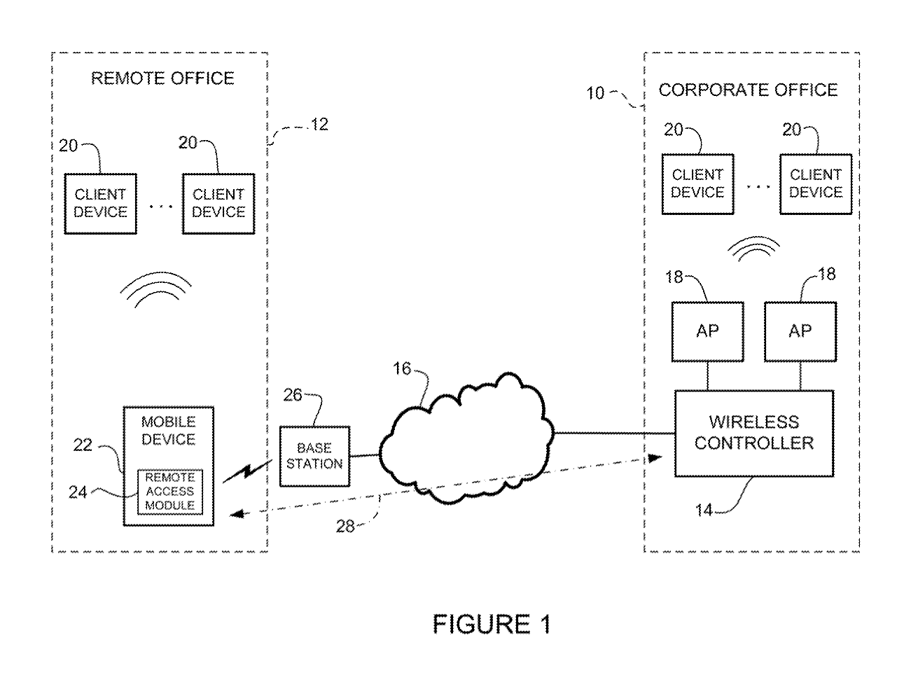

Referring now to the drawings, and first to FIG. 1, an example of a network in which embodiments described herein may be implemented is shown. For simplification, only a small number of network devices are shown. The network includes a corporate office site (e.g., enterprise, corporate headquarters, branch office, campus environment) 10 in communication with a remote location (e.g., home office, remote office, remote branch office) 12. The corporate site 10 includes a wireless controller 14 in communication with the remote site 12 via network 16. The wireless controller 14 is in wired communication with one or more access points (APs) 18 for wireless communication with any number of client devices 20 via a wireless network (e.g., WLAN (wireless local area network)) at the corporate site. The term ‘wireless controller’ as used herein may refer to a mobility controller, wireless control device, wireless control system, or any other network device operable to perform control functions for a wireless network.

The wireless controller 14 enables system wide functions for wireless applications and may support any number of access points 18 in the corporate office 10. Each access point 18 may serve any number of client devices 20 in the wireless network at the corporate office 10. As described below, the wireless controller 14 also supports any number of remote access modules 24 installed at mobile devices 22 at remote offices 12. In one embodiment, the wireless controller 14 is configured for data encryption for added security across remote WAN (wide area network)/LAN (local area network) links. The wireless controller 14 includes one or more processor, memory, and interfaces (e.g., Ethernet ports for communicating with network devices). The wireless controller 14 may be, for example, a standalone device or a rack-mounted appliance.

The corporate site 10 may also include a wireless control system or other platform for centralized wireless LAN planning, configuration, and management. The wireless controller 14 may be in communication with one or more corporate networks (e.g., local area network, private network, virtual private network, wireless local area-network) at the corporate office site or another location.

The corporate office 10 is in communication with the remote office 12 via network 16. The network 16 may include one or more networks (e.g., local area network, wireless local area network, cellular network, metropolitan area network, wide area network, satellite network, Internet, intranet, radio access network, public switched network, virtual private network, or any other network or combination thereof). Communication paths between the corporate office 10 and remote office 12 may include any number or type of intermediate nodes (e.g., routers, switches, gateways, or other network devices), which facilitate passage of data between the sites.

The remote office 12 includes the mobile device 22 configured to operate as a remote access point for one or more client devices 20 located at the remote office. As described in detail below, the mobile device 22 includes a remote access module (e.g., software, application, code, program, device) 24 that creates a secure tunnel 28 with the wireless controller 14 so that the mobile device can operate as a Wi-Fi hotspot for the corporate office network. The remote access module 24 is provisioned using the wireless control system and automatically sets up the secure tunnel 28 to the corporate office 10 with the wireless controller 14. In one embodiment the remote access module 24 establishes a secure Datagram Transport Layer Security (DTLS) connection 28 between the mobile device 22 and the wireless controller 14. The connection 28 provides remote WLAN (wireless LAN) connectivity using the same profile as at the corporate office 10. The same services that are available on the wireless network at the corporate office 10 are securely accessible via the remote access module 24 installed at the mobile device 22. For example, data, voice, and video, as well as conferencing applications and dual-mode or voice over IP (Internet Protocol) phones may be supported at the remote office 12.

In one embodiment, the secure tunnel 28 is created using CAPWAP (Control and Provisioning of Wireless Access Points) protocol. CAPWAP is a standard interoperable protocol that enables the wireless controller 14 to manage a collection of wireless access points. In the embodiments described herein, the collection of access points includes access points 18 in the corporate office 10 and one or more remote access modules 24 operating as an access point at one or more remote offices 12. It is to be understood that this is only an example and that other protocols, such as LWAPP (Lightweight Access Point Protocol) may also be used.

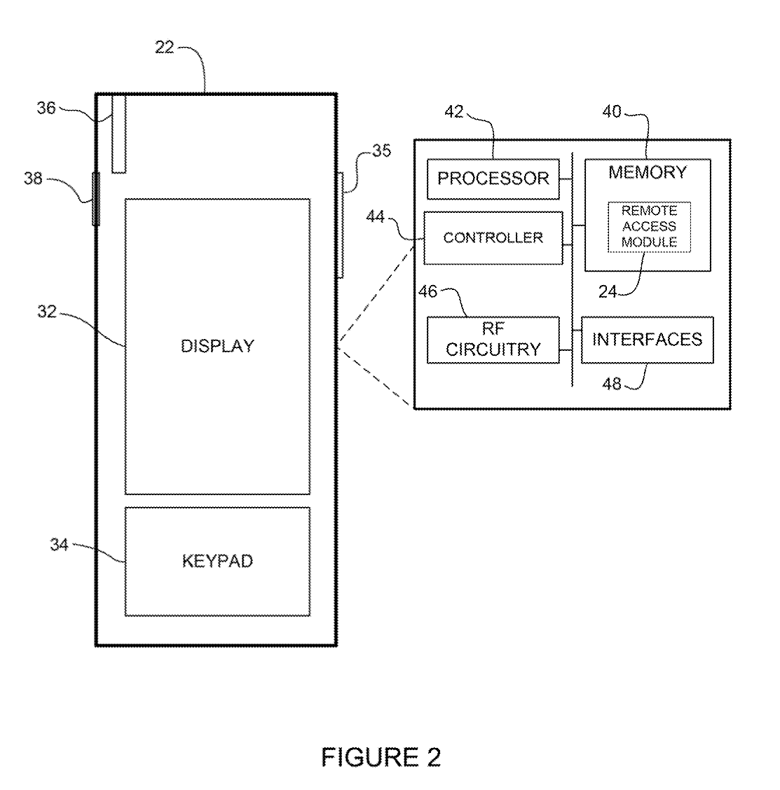

The mobile device 22 may be any suitable equipment that supports wireless communication, including for example, a cellular phone, personal digital assistant, portable computing device, tablet/multimedia device, and the like. In the example shown in FIG. 1, the mobile device 22 is in communication with a base station 26, which connects to a wired data network and serves as a gateway or access point through which the mobile device 22 has access to the network 16. The mobile device 22 and base station 26 each include one or more antenna for wireless communication (e.g., 3G/4G (third generation/fourth generation of cellular wireless standards) wide area network (WAN) connection). If the mobile device 22 includes two Wi-Fi interfaces, the mobile device may also communicate with, an access point in communication with network 16, rather than the base station 26. Details of one example of the mobile device 22 are described below with respect to FIG. 2.

The client device 20 may be, for example, a personal computer, laptop mobile phone, tablet, personal digital assistant, voiceover IP phone, or any other wireless device. The mobile device 22 and client devices 20 at the remote office 12, and the access points 18 and client devices at the corporate office 10 are configured to perform wireless communication according to a wireless network communication protocol such as IEEE 802.11 or other wireless transmission protocol.

It is to be understood that the network shown in FIG. 1 and described herein is only an example and that other networks having different components or configurations may be used, without departing from the scope of the embodiments. For example, the wireless controller 14 may support any number of remote access modules 24 installed at mobile devices 22 located at any number of remote offices 12.

FIG. 2 illustrates an example of a mobile device 22 in which embodiments described herein may be implemented. The mobile device 22 includes a visual display 32 and a keypad 34 comprising multiple keys (not shown) used in operation of the device. The keypad 34 may also be a touch screen integrated with the display 32. The keypad 34 may include numeric keys, alphabetic keys, standard telephone keys, or any other icons or symbols. The mobile device 22 may include any number of other user interfaces such as one or more manual buttons (e.g., switch 35). A user can select and activate the remote access module 24 by touching the screen (e.g., selecting an icon on the touch screen) or pressing one or more buttons. The user can input information (e.g., user identifier or password, mobile device identifier, wireless controller or control system identifier) using the keypad 34 or graphical user interface, for example. After the remote access module 24 is activated and user information is provided, the user may be presented with an option such as “Press to start tethering.” Once the connection with the wireless system at the corporate site 10 is established, another message may be displayed on the touch screen (e.g., “Press to stop tethering.”).

The mobile device 22 also includes an antenna 36, which may be internal or external to the device, for wireless communications. One or more external ports 38 may be provided for connection with another input or output device. The device 22 may also include one or more speakers and one or more microphones (not shown).

As illustrated in the block diagram of FIG. 2, the mobile device 22 further includes memory 40, one or more processors 42, mobile device controller 44, RF (Radio Frequency) circuitry 46, and interfaces 48.

Memory 40, which may include one or more computer readable storage mediums, may be any form of volatile or nonvolatile memory, including for example, random access memory (RAM), read-only memory (ROM), magnetic media, optical media, flash memory, removable media, or any other suitable memory component. Memory 40 may store any data or information, including software and encoded logic, utilized by the mobile device 22. Memory 40 also includes software components such as remote access module 24 and an operating system. The memory 40 may also store a mobile device identifier, user identifier, wireless controller identifier, wireless control system identifier, or any combination thereof.

The one or more processors 42 run of execute Various code, software programs, or instructions stored in memory 40 to perform functions for the device 22 and to process, data. Logic may be encoded in one or more tangible media for execution by the processor 42. For example, memory 40 can be utilized to store and retrieve software programs incorporating computer code that implements aspects of the embodiments, data for use with the embodiments, and the like. The mobile device 22 includes any suitable combination of hardware, software, or encoded logic operable to send, receive, and process data or signals.

The RF circuitry 46 receives and transmits RF signals and converts electrical signals to or from electromagnetic signals and communicates with communication devices via the electromagnetic signals. Communication circuitry allows the mobile device to communicate with other network devices using any suitable communications protocol.

The mobile device controller 44 provides for management and control of various elements within the device 22. For example, the controller 44 may access information maintained within memory 40 and control other elements to interact with users and other communication devices.

The interfaces 48 include at least two interfaces for communication with the wireless controller 14 at the corporate site 1Q and client device 20 at the remote site 12. The interfaces 48 may comprise, for example, a radio interface (e.g., 3G/4G radio interface) for communication with the wireless controller 14 via base station 26 and a Wi-Fi interface for communication with the client device 20. As noted above, the mobile device 22 may also operate with two WiFi interfaces.

It is to be understood that the device 22 shown in FIG. 2 and described herein is only one example of a mobile device, and that the device may have additional, fewer, or different components, or a different arrangement or configuration of components, without departing from the scope of the embodiments. For example, the mobile device 22 may further include any suitable combination of hardware, software, algorithms, processors, devices, components, or elements operable to facilitate the capabilities described herein.

If the remote access module 24 is not already installed on the mobile device 22, the user can download an application from a site containing the application (e.g., application store) or install the module by other means. For the initial setup, the user is prompted with instructions to provide a unique device identifier to the corporate office to have the mobile device 22 provisioned as a remote access point. The identifier may be, for example, a MAC address, cryptographic digest, service set identifier (SSID), mobile subscriber identity located in a SIM (subscriber identity module) card, or other identifier or combination of identifiers. The user inputs to the remote access module 24 a wireless controller identifier (e.g., server name of the wireless control system), which may be provided to the user by a network administrator. The remote access module 24 can then automatically set up a secure tunnel to the corporate headquarters with the wireless controller 14, as described below.

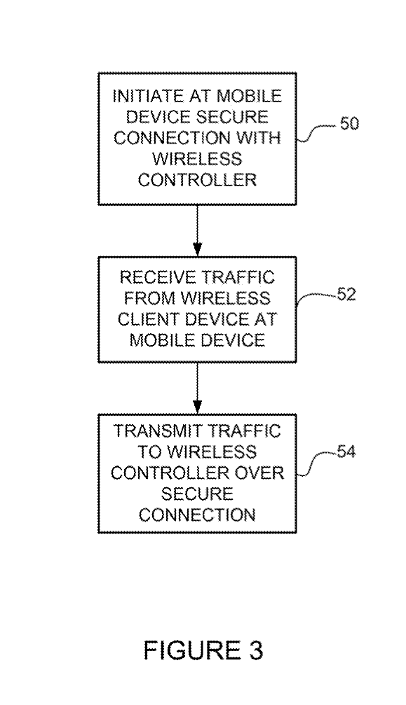

FIG. 3 is a flowchart illustrating an example of remote secure access to a wireless network at a mobile device, in accordance with one embodiment. The remote access module 24 is installed on the mobile device 22 and initialized (e.g., user inputs network and device information), as described above. At step 50, the remote access module 24 initiates a secure connection with the wireless controller 14 of the wireless network at the corporate office 10 (first wireless network). As described above, the mobile device 22 is located remote from the wireless network (i.e., out of signal range from the wireless network). The secure connection 28 may be, for example, a secure DTLS VPN (tunnel) 28 with endpoints at the mobile device 22 and the wireless controller 14. In one embodiment, initiating a secure connection includes discovering the wireless controller 14 by using a CAPWAP discovery mechanism and sending the controller a CAPWAP join request. The controller 14 responds with a CAPWAP join response, which allows the remote access module 24 to join the controller. The wireless controller 14 configures the remote access module 24 to extend the corporate wireless network. When the remote access module 24 joins the controller 14, the controller manages its configuration, firmware, control transactions, and data transactions.

At step 52, the mobile device 22 receives traffic (e.g., data, audio, video, request for services) from wireless client device 20 at the remote office 12 and destined for the network at the corporate office 10. The mobile device 22 transmits the traffic to the wireless controller 14 over the secure connection 28 (step 54). The remote access module 24 operates as a Wi-Fi hotspot in the wireless network at the remote office 12 (second of remote wireless network) and all traffic to and from the corporate network is securely tunneled on the secure connection 28 over the 3G/4G radio interface.

It is to be understood that the process illustrated in FIG. 3 is only an example and that steps may be modified or added without departing from the scope of the embodiments.

Although the method and apparatus have been described in accordance with the embodiments shown, one of ordinary skill in the art will readily recognize that there could be variations made without departing from the scope of the embodiments. Accordingly, it is intended that all matter contained in the above description and shown in the accompanying drawings shall be interpreted as illustrative and not in a limiting sense.

1. A method comprising:
initiating at a mobile device, a secure connection with a wireless controller of a wireless network, the mobile device located remote from the wireless network;
receiving traffic from a wireless client device at the mobile device; and
transmitting the traffic to the wireless controller over the secure connection;
wherein the mobile device extends the wireless network to the remote location.

2. The method of claim 1 wherein the secure connection extends over a wide area network.

3. The method of claim 1 wherein the secure connection extends over a cellular network.

4. The method of claim 1 wherein initiating comprises discovering and joining the wireless controller.

5. The method of claim 1 wherein initiating comprises utilizing control and provisioning of wireless access points protocol.

6. The method of claim 1 wherein initiating is performed by application software installed at the mobile device.

7. The method of claim 1 wherein the wireless network comprises a corporate network and the mobile device is located at a remote site.

8. The method of claim 1 wherein transmitting the traffic comprises utilizing datagram transport layer security protocol.

9. The method of claim 1 further comprising receiving an identifier for the wireless controller at the mobile device and wherein initiating comprises transmitting a unique mobile device identifier to the wireless controller.

10. An apparatus comprising:
a processor for initiating at a mobile device, a secure connection with a wireless controller of a wireless network located remote from the mobile device, receiving traffic from a wireless client device, and transmitting the traffic to the wireless controller over the secure connection; and
memory for storing an identifier for the wireless controller;
wherein the mobile device extends the wireless network to the remote location.

11. The apparatus of claim 10 further comprising a radio interface for communication with the wireless controller and a Wi-Fi interface for communication with the wireless client device.

12. The apparatus of claim 10 wherein the memory stores remote access application software for use in initiating the secure connection.

13. The apparatus of claim 10 wherein initiating comprises discovering and joining the wireless controller.

14. The apparatus of claim 10 wherein initiating comprises utilizing control and provisioning of wireless access points protocol.

15. The apparatus of claim 10 wherein the secure connection comprises a datagram transport layer security tunnel.

16. The apparatus of claim 10 wherein initiating comprises transmitting a unique mobile device identifier to the wireless controller.

17. Logic encoded on one or more tangible computer readable media for execution and when executed operable to:
initiate at a mobile device, a secure connection with a wireless controller of a wireless network located remote from the mobile device;
receive traffic from a wireless client device at the mobile device; and
transmit the traffic to the wireless controller over the secure connection;
wherein the mobile device extends the wireless network to the remote location.

18. The logic of claim 17 wherein the secure connection comprises a datagram transport layer security tunnel with endpoints at the mobile device and the wireless controller.

19. The logic of claim 17 wherein services available at the wireless network are accessible to the wireless client device via the mobile device.

20. The logic of claim 17 wherein the wireless controller is in communication with a plurality of client devices in the wireless network and one or more of the mobile devices at one or more remote wireless networks.
